(19) United States
(12) Patent Application Publication
(10) Pub. No.: US 2005/0032564 A1
(43) Pub. Date: Feb. 10, 2005

(54) Methods and apparatus for playing a poker game

(76) Inventor: Randy D. Sines, Spokane, WA (US)

Correspondence Address: John S. Reid;Reidlaw, L.L.C., 1926 S. Valleyview Lane, Spokane, WA, 99212-0157, US

(21) Appl. No.: 10/858,160

(22) Filed: Jun. 1, 2004

Related U.S. Application Data
(63) Continuation-in-part of application No. 10/637,238, filed on Aug. 8, 2003.

(51) Int. Cl. A63F 13/00

(52) U.S. Cl. 463/13

(57) ABSTRACT

Representative embodiments provide a method for playing poker, including defining a qualifying hand and collecting an ante from one or more players. The method also includes dealing an initial hand to each player, accepting a bet into a pot from at least one player, and dealing at least one additional card to the betting players. The method includes awarding the pot to a player who has a lowest qualifying according to a lo-ball ranking of poker hands. If no player has a qualifying hand, the method includes repeating collecting an ante and dealing an initial hand and accepting a bet and dealing at least one additional card, and including in the pot at least a portion of any previously unawarded pot or pots until the pot is awarded. Also provided are a gaming table and individual gaming machines for playing the poker games of the present invention.

### CROSS REFERENCE TO RELATED APPLICATIONS

This application is a continuation-in-part of co-pending U.S. patent application Ser. No. 10/637,238, filed Aug. 8, 2003, which is hereby incorporated by reference herein in its entirety.

### BACKGROUND

Various kinds of wagering games are known. Examples of such wagering games include craps, blackjack (twenty-one), baccarat, etc. Play of such a wagering game typically involves a player's individual skill, playing strategy, and some degree of probabilistic chance operating within the rules of the game to determine a winner or winners. Commonly, wagering games are played within a casino, card house, or similar establishment in which players can enjoy numerous amenities such as beverage and food services, cashier services, lines of credit, personal security, or other resources that generally make for an attractive atmosphere in which to play such wagering games.

Generally, players take significant interest in a particular type of wagering game and the challenge offered in playing that game well. As a result, some degree of variation in the rules and/or other dynamics of play are sought by a number of players so that the particular wagering game of choice continues to provide interest and excitement. Furthermore, an increasing number of wagering games can now be played in a manner that is, to some extent, computerized or automated. In such a venue, certain tasks such as, for example, the dealing of cards, accounting for wagers, and the awarding of winnings is handled automatically so that players are better able to concentrate on and enjoy the play of the game.

Therefore, it is generally desirable to provide methods and apparatus for playing wagering games that provide interest and excitement to the players.

### SUMMARY

The present invention provides for any number of different poker games. Typical to each of the poker games of the present invention is the use of a standard poker deck, including the use of two jokers (wild cards). Various stud and draw versions of the game are provided, wherein betting is a predefined amount. The present invention further provides variations referred to as lo-ball poker. As betting (wagering) during the particular poker game is performed substantially simultaneously by each player, the overall progress (play) of the game is generally faster than that of known styles of poker game play.

Furthermore, the present invention provides for substantially automated (i.e., electronic) venues for play of the instant poker games. Such venues include a wager gaming table configured to provide play for a plurality of players, as well as individual gaming machines that can be played as a collective network. Of course, the poker games of the present invention can also be played in a more traditional environment on a known poker table, through the use of conventional poker playing cards and wagering chips, etc. Also, typical embodiments of the poker games of the present invention include the dealing of all cards in a face-up condition. However, other variations can be played in which some or all of the cards are dealt in a face-down condition.

One embodiment of the present invention provides a method for playing a poker game, the method including the steps of defining a qualifying hand, and the dealing of an initial hand of at least one card to each of one or more players. The method also includes the acceptance of a bet into a pot from each of at least one of the players. Furthermore, the method includes the step of awarding the pot to any betting player who has a lowest hand that comprises a qualifying hand. In the event that no player has a qualifying hand, the method includes repeating the steps of dealing an initial hand to one or more players, and the accepting of a bet from one or more players, and including in the pot at least a portion of any previously unawarded pot or pots, until the pot is awarded.

Another embodiment of the present invention provides a gaming table, the gaming table including a plurality of user interfaces, and an electronic controller coupled in signal communication with each of the user interfaces. The electronic controller is configured to define a qualifying hand, and to deal an initial hand of at least one card to each of at least two players by way of the user interface corresponding to the player. The electronic controller is further configured to record a bet into a pot from each of at least one of the players, by way of the corresponding user interface. The electronic controller is also configured to deal at least one later card to each of one or more betting players by way of the corresponding user interface. Furthermore, the electronic controller is configured to award the pot to any betting player who has a lowest hand that comprises a qualifying hand by way of the corresponding user interface. If no player has a qualifying hand, the electronic controller is further configured to repeat the dealing of an initial hand, and the recording of a bet from one or more betting players, and the dealing of at least one later card to each of the betting players, and to include in the pot at least a portion of any previously unawarded pot or pots, until the pot is awarded.

Yet another embodiment of the present invention provides for a computer-accessible storage media including an executable program code. The executable program code configured to cause a processor to define a qualifying hand, and to deal an initial hand of at least one card to each of one or more players. The dealing of cards is performed by way of respective user interfaces coupled to the processor. The executable program code is also configured to cause the processor to record a bet into a pot from at least one of the players by way of the respective user interface, and to deal at least one later card to each betting player by way of the respective user interface. Furthermore, the executable program code is configured to cause the processor to award the pot to any betting player who has a lowest hand that comprises a qualifying hand by way of the respective user interface. If no player has a qualifying hand, the executable program code is configured to cause the processor to repeat the dealing of an initial hand and the recording of a bet and the dealing of at least one later card, and to include in the pot at least a portion of any previously unawarded pot or pots, until the pot is awarded.

Another embodiment of the present invention provides a method of playing a poker game, the method comprising the steps of defining a qualifying hand, and the collecting an ante from each of one or more players. The method also includes the steps of dealing an initial hand of at least one card to each of the players, and the accepting a bet into a pot from at least one of the players. The method further includes the steps of dealing at least one additional card to one or more of the betting players, and the awarding of the pot to any betting player who has a lowest hand that comprises a qualifying hand in accordance with a predetermined lo-ball ranking of poker hands. In the event that no player has a qualifying hand, the method includes the steps of repeating the collecting of an ante and the dealing of an initial hand and the accepting of a bet and the dealing of at least one additional card, and includes in the pot at least a portion of any previously unawarded pot or pots, until the pot is awarded.

These and other aspects and embodiments will now be described in detail with reference to the accompanying drawings, wherein:

### DESCRIPTION OF THE DRAWINGS

FIG. 1 is a flowchart depicting a method of playing a poker game in accordance with one embodiment of the present invention.

FIG. 2 is a flowchart depicting a method of playing a poker game in accordance with another embodiment of the present invention.

FIG. 3 is a plan view depicting a wager gaming table in accordance with still another embodiment of the present invention.

FIG. 4 is front elevation view depicting a gaming network in accordance with the yet another embodiment of the present invention

FIG. 5 is a front elevation view depicting an exemplary display in accordance with still another embodiment of the present invention.

FIG. 6 is a flowchart depicting a method of playing a poker game in accordance with another embodiment of the present invention.

FIG. 7 is a flowchart depicting a method of playing a poker game in accordance with yet another embodiment of the present invention.

FIG. 8 is a table depicting a hierarchical ranking of poker hands corresponding to the embodiments of FIGS. 6 and 7.

### DETAILED DESCRIPTION

In representative embodiments, the present teachings provide methods and apparatus for playing a poker game including wagering.

Certain terms are used and applied herein that are generally defined as follows:

House: The house is a game administrator or host for playing a game or games in accordance with the teachings of the present invention. In some circumstances, the house can be generally defined by a casino, or the agents thereof, which is/are authorized to define particular rules or other aspects of playing the game or games of the present invention. In other situations, the house can be defined by one or more individuals hosting or otherwise officiating the play of a game or games as provided herein. Such individuals are commonly referred to as dealers.

Rake: The rake is a portion of the wagers or other designated monies or valuables put forth by the player or players of a game that is extracted (taken) by the house as charge for playing the game. The rake may be a predefined percentage of the wagers, a fixed amount taken from the wagers, or some other function of the wagers or other monies or valuables put forth (bet or risked) during the play of the game.

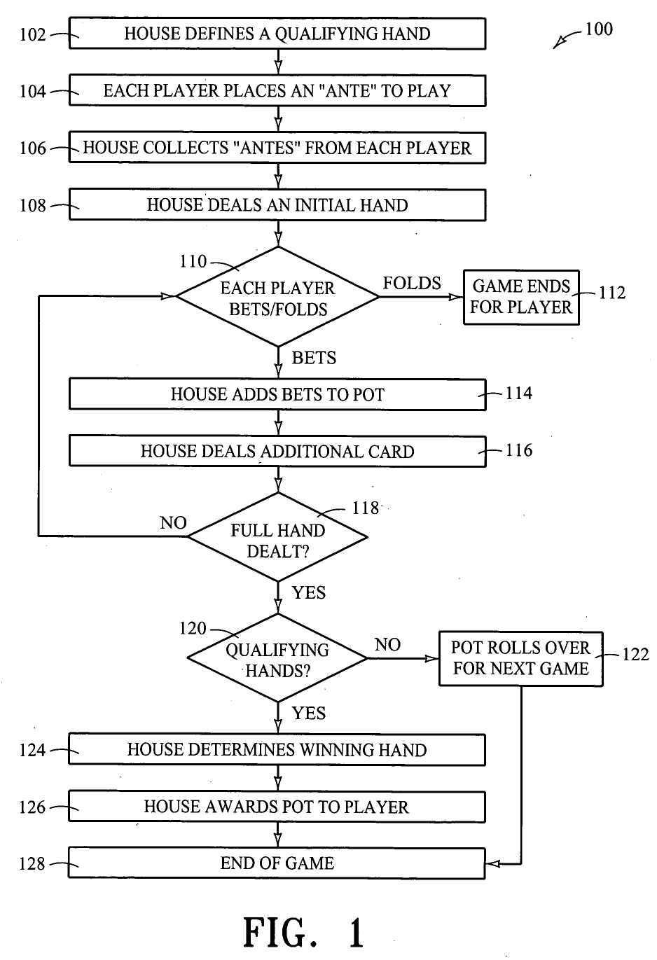

Turning now to FIG. 1, a flowchart 100 depicts a method for playing a poker game in accordance with one embodiment of the present invention. The embodiment described in the method depicted by flowchart 100 is generally considered a “stud” version of the poker game of the present invention. While the method depicted by flowchart 100 describes particular steps and order of execution, it is to be understood that other embodiments of the present invention that respectively include other steps and/or orders of execution can also be used in accordance with the teaching of the present invention.

In step 102 of flowchart 100, the house defines a qualifying hand for play of the poker game. The qualifying hand is generally considered a minimum hand necessary for a player to qualify for winning a collective pot (described hereafter). The qualifying hand is ranked relative to other hands in accordance with typical rules for playing poker. One of skill in the poker gaming arts is familiar with such rankings (i.e., hierarchy of hands), and an exhaustive elaboration is not required for purposes herein. Qualifying hands can include, for example, two of a kind, three of kind, two pair, a pair of jacks or better, etc. Other qualifying hands can also be defined and used, for example, in accordance with a consensus of the player(s) prior to the beginning of the poker game.

In step 104, each of one or more players places (i.e., puts forth) an ante so as to establish their initial participation in the game about to commence. Typically, the ante is a fixed amount of money predefined by the house. All of the antes put forth by the players can be collectively considered an ante pool.

In step 106, the house collects the collective antes (i.e., ante pool) as its share for hosting, or officiating, the present game.

In step 108, the house deals an initial hand of one or more cards—in accordance with the present embodiment of poker game being played—in a face-up condition to each of the players participating in the game (i.e., those players that have anted; also considered valid players for purposes herein). For purposes of example, it is assumed that an initial hand of three cards is dealt to each valid player and that a full hand constitutes five cards total for the present embodiment of the game. Other card counts corresponding to other initial hands and full hands can also be used. Further, it is assumed that cards used during play are dealt from a standard (fifty two card) poker deck or its equivalent. Further still, the two standard jokers (wild cards) can also be used.

In step 110, each player decides if they are to continue the game or quit at this point without further play of the present game. Those players who elect to quit, or ‘fold’ continue to step 112 below. Those players that elect to continue play continue to step 114 below.

In step 112, those players electing to quit in step 110 above, do so. The present instance of the game of flowchart 100 is now ended for those players. However, players that fold at this point are eligible to continue play in the next (sequential) game and can therefore continue to compete with other players for the same collective pot, should it not be awarded to a player or players at the end of any current round of the poker game.

In step 114, each player that elected to continue play in step 110 above now places a respective wager, or bet, into a collective pot. For purposes herein, each of these wagers can also be considered an initial bet. It is to be understood that each of the wagers is of equivalent value, and is typically predefined by the house as a minimum initial bet or wager. The amount of the minimum initial bet can be fixed for all instances of playing the game, or can change from time to time. In another embodiment of the game, for example, the amount of the initial bet escalates (increases) in value with each successive instance of playing the poker game. Other strategies of establishing the minimum initial bet can also be used.

In any case, the (initial) bet or bets from the player or players are placed into a collective pot that includes any residual bet or bets not yet awarded to a player or players from previous play(s) of the poker game of flowchart 100. In another embodiment, the house takes a rake (or a percentage) out of the collective pot at this time, once betting following the dealing of the initial hand in step 108 is complete. It is to be understood that the betting players place their respective equivalent bets in a near simultaneous fashion. In this way, the substantially traditional system of call/check/raise is typically not applicable to the stud poker game(s) of the present invention, although such check/call/raise features are not precluded under poker games of the present invention. Thus, the stud poker game of flowchart 100 results in a generally faster sequence of play relative to that of substantially traditional poker. Furthermore, betting is typically performed in equal amounts within each round of a poker game of the present invention.

In step 116, the house deals an additional card in a face-up condition to each of the presently valid players. In the present example, each player now holds four cards of a five card full hand.

In step 118, it is determined if each player now has a full hand. In the present example, each valid player is due one more card. In such a case (where one or more additional cards are due), the flowchart 100 returns to steps 110 through 116 above, repeatedly as needed, in accordance with the present embodiment of the poker game in progress. During such repeat of step 114 above, after each valid player has been dealt a final card in step 116 above (i.e., each valid player has a full hand), the flowchart 100 proceeds to step 120 below.

In step 120, the house determines if any of the valid players has a qualifying (final) hand. If one or more players has a qualifying hand, then the flowchart 100 proceeds to step 124 below. If none of the players has a qualifying hand, then the flowchart 100 proceeds to step 122 below.

In step 122, the house sets the present collective pot aside for use in the next instance of playing the game. In this way, the collective pot can be considered a “progressive” pot. The flowchart 100 then proceeds to step 128 in which the present instance of the poker game is ended without awarding the collective pot to any player or players. The present instance (iteration) of the poker game provided by flowchart 100 is considered complete.

In step 124, the house evaluates and compares any qualifying hands held by one or more of the players in accordance with standard (or other defined) hierarchical rules of poker, to determine which is a superior (or “best”) qualifying hand, or if equivalent superior qualifying hands are held by two or more players.

In step 126, the house awards the collective pot to a single player (winner) holding the superior qualifying hand as determined in step 124 above. If two (or more) players hold equivalent superior qualifying hands, then the collective pot can be equally split between them.

In step 128, the present instance of the poker game is considered complete. If the collective pot has not been awarded during the most recent instance of the game, the poker game of the flowchart 100 is typically repeated, as one or more additional instances of the poker game, until the collective pot is finally awarded to one or more of the present players.

The flowchart 100 as described above generally provides for one possible embodiment of playing a game of “stud” poker in accordance with the present invention. Other embodiments corresponding to other steps, procedures and/or orders of execution can also be used. It is important to note that numerous aspects of the flowchart 100 can be suitably varied, typically by the house and/or in accordance with player agreement. For example, the ante put forth by the players in step 104 above can be either fixed or varying. Such a varying ante can be defined by an escalating ante that increases with each successive instance of playing the poker game of flowchart 100. Such a varying (e.g., escalating) ante is desirable to the house as it usually corresponds to higher earnings or profits in exchange for hosting the game. Other forms of varying ante can also be used.

Furthermore, certain embodiments of the poker game of the present invention can also include a jackpot or a progressive (i.e., accumulating) jackpot that is awarded to a player that holds a correspondingly predefined hand (for example, during step 126 above). For example, a progressive jackpot can be awarded to a player whose final hand constitutes a straight flush (or better). In another example, a jackpot can be awarded to a player whose final hand constitutes four-of-a-kind (or better). Other types of jackpots awarded for correspondingly predefined hands can also be used.

Typically, the amount of a progressive jackpot is increased by way of adding a portion from each of the antes (e.g., the ante pool) put forth by the players during each game (for example, as in step 104 above). This strategy can be attractive to both the players and the house, as the house can charge an incrementally higher ante while providing the progressive jackpot as an exciting inducement to the players of the poker game. On the other hand, a jackpot can be provided as a fixed value, house funded incentive with no apparent bearing on a player's antes or wagers. Also, other jackpot or progressive jackpot schemes can be used.

In yet another embodiment of the flowchart 100, the house can offer a “bad beat” jackpot to a player that holds an otherwise exceptional qualifying hand when that player loses to another player with a generally very rare, superior qualifying hand. For example, a player may qualify for a jackpot with a hand of four-of-a-kind, only to lose to a player that holds a royal flush. While the probability of such circumstances are quite rare, a bad beat jackpot can provide additional inducement to players to participate in the game despite such a possibility.

In yet another embodiment of the stud poker game of flowchart 100, any player electing to ‘sit out’ for a hand (not participate) in the present instance of the game forfeits their option to continue playing toward the present collective pot. Thus, under such an embodiment, the collective pot at hand is particular to the specific player or players whose poker play resulting in the creation and perpetuation of the present collective pot, and such collective pot will not be awarded to another player or other players.

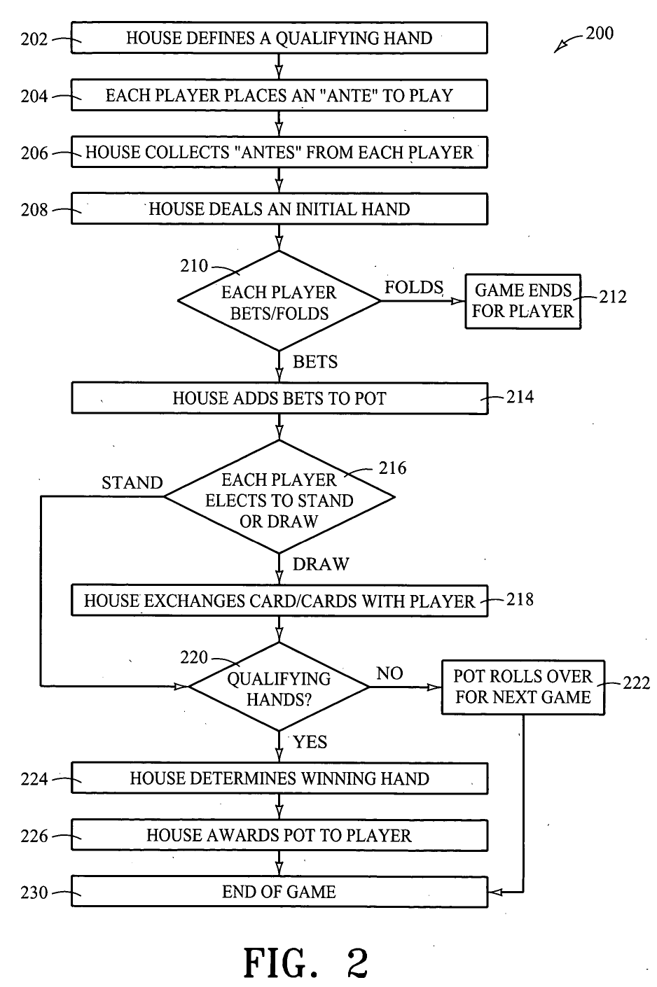

FIG. 2 is a flowchart 200 depicting a method of playing a poker game in accordance with another embodiment of the present invention. The embodiment described in flowchart (method) 200 is generally considered a “draw” version of the poker game of the present invention. While the flowchart 200 describes particular steps and order of execution, it is to be understood that other embodiments of the present invention that respectively include other steps and/or orders of execution can also be used in accordance with the teaching of the present invention.

In step 202, the house defines a qualifying hand for playing the poker game in accordance with the flowchart 200. As described above in regard to step 102 of the flowchart 100 of FIG. 1, the qualifying hand is generally considered a minimum hand necessary for a player to qualify for winning a collective pot. As also described above, the qualifying hand is ranked relative to other hands in accordance with typical (or otherwise reestablished) rules for playing poker.

In step 204 of flowchart 200, each player places or puts forth an ante as an initial qualification for participating in the present instance of the poker game.

In step 206, the house collects the collective antes (ante pool) as its share.

In step 208, the house deals an initial hand of one or more cards, to each of one or more valid (anteing) players, in a face-up condition. The number of cards dealt in the initial hand is determined in accordance with the particular embodiment of the poker game in progress. For purposes of example, it is assumed that an initial hand of five cards is dealt to each of the valid players. Furthermore, the initial hand constitutes a full hand within the context of the flowchart 200.

In step 210, each of the players decides either to place a bet or to fold (quit). Those players electing to fold proceed to step 212 below. Those players that elect to place a bet and continue playing the poker game advance to step 214 below.

In step 212, each player electing to quit in step 210 above does so at this point. The present instance of the poker game of flowchart 200 is now considered complete for such a player or players.

In step 214, those players that elected in step 210 above to continue put forth a bet (i.e., initial bet). The house then adds the bets to a collective pot. Generally, such bets (initial bets) are of a fixed amount predefined by the house. Other bet establishing strategies such as minimum betting, for example, can also be used. In any case, all of the bets are typically of equal amount and are placed by the respective players in a substantially simultaneous fashion. In another embodiment, the house extracts a percentage or rake for itself from the collective pot at this time.

In step 216, each valid (betting) player elects to stand with their initial hand, or to draw one or more cards in accordance with the number of cards in the present full hand. Those players electing to stand continue to step 220 below. Those players electing to draw continue to step 218.

In step 218, the house exchanges one or more cards with each of those valid players electing to draw. That is, each drawing player individually selects what particular card or cards to discard from their initial hand in exchange for a new card or cards dealt, face-up, by the house. In another embodiment, the house accepts an additional bet from each of one or more players placing an initial bet (i.e., valid players). Typically, such an embodiment includes the dealing (exchanging) of cards in a face-down condition prior to the accepting the additional bet or bets.

In step 220, the house determines if any of the valid players has a qualifying (final) hand. If one or more players has a qualifying hand, then the flowchart 200 proceeds to step 224 below. If none of the players has a qualifying hand, then the flowchart 200 proceeds to step 222 below.

In step 222, the house sets the collective pot aside for use in the next instance of playing the game according to the flowchart 200. In this way, as described in the flowchart 100 above, the collective pot can be considered a progressive pot. The flowchart 200 then proceeds to step 228 in which the present instance of the draw poker game is ended without awarding the collective pot to any winner or winners. The present instance (iteration) of the poker game provided by flowchart 200 is then considered complete.

In step 224, the house evaluates and compares any qualifying hands held by one or more of the players in accordance with standard or other predefined hierarchical rules of poker to determine which is a superior qualifying hand or if equivalent superior qualifying hands are held by two or more players.

In step 226, the house awards the collective pot to a single player holding the superior (“best”) qualifying hand as determined in step 224 above. In the alternative, if two (or more) players hold equivalent superior qualifying hands, then the collective pot can be equally split between them.

In step 228, the present instance of the draw poker game according to the flowchart 200 of FIG. 2 is considered complete. In the event that no player or players is/are awarded the collective pot in step 226 above; play of the poker game of the flowchart 200 is substantially repeated until the collective pot is awarded to one or more of the original players (associated with the creation of the present collective pot).

The flowchart 200 as described above generally provides for one embodiment of playing a game of “draw” poker in accordance with the present invention. Other embodiments corresponding to other steps, procedures and/or orders of execution can also be used. It is to be noted that various aspects of the game can be altered from those as described in regard to the flowchart 200 of FIG. 2 in accordance with the present invention. For example, such aspects as a varying (e.g., escalating) ante, and/or the offering of a jackpot, progressive jackpot, and/or bad beat jackpot can also be used substantially as described above (respectively) in regard to the flowchart 100 of FIG. 1. Other embodiments of a draw poker game can include, for example, those aspects or features substantially as described above in regard to the stud poker game of the flowchart 100.

It will be appreciated that, in variations of the methods described above, cards can be dealt in any manner of face-up and/or face-down initial orientation. For example, in a stud version (similar to that described in flowchart 100) two cards can be dealt face up, and a third card dealt face-down. Two additional cards can be dealt in separate betting cycles, each face up. After the last (e.g., fifth) card has been dealt and bets place, the face-down card can be turned face up. In another example five cards can be dealt all initially in a face-down orientation, and the cards turned face-up, one at a time during each betting cycle, until the last card has been turned face-up, at which time it is determined if any player or players have qualifying hands and, if so, which of the qualifying hands is the best hand.

The methods described above can also incorporate the use of “wild cards”, such as jokers or other special cards, which can be designated by a player as whatever value the player chooses to facilitate achieving a qualifying hand, or a best qualifying hand.

As can be seen by the example depicted in flowchart 100, one feature of a poker game in accordance with the present invention is that play of the game among the players can be performed essentially simultaneously. That is, each time cards are dealt to the players, all players can bet simultaneously, verses betting sequentially as in traditional poker games (i.e., where players individually and sequentially elect to fold, meet a current bet, or raise the current bet). This feature of the games of the present invention allows for faster play.

Another feature of a poker game in accordance with the present invention is that the house can take the ante, thus ensuring a known income for the house. The house can establish the ante to cover its costs of hosting the game, as well as making a profit. Further, the house can elect to put some of the ante money into a special jackpot to enhance attractiveness of the game. Further, between games the house can change the amount of the ante (e.g., increase the ante to cover higher costs or make additional profit, or lower the ante to attract more players). One benefit of this arrangement of the house taking the ante is that the players know that they are essentially playing against one another, versus playing against the house. Consequently, players may be more inclined to play the game since there is essentially a guarantee that all bets (excluding the ante) will eventually be won by one of the players, and not by the house.

While the respective stud (flowchart 100) and draw (flowchart 200) poker games described above can be played, for example, within the context of traditional (discrete) playing cards and wagering chips, it is to be understood that the games of the present invention can also be played through the use of suitable, substantially electronic wager gaming apparatus. Examples of such apparatus as provided by the present invention are described in detail hereafter.

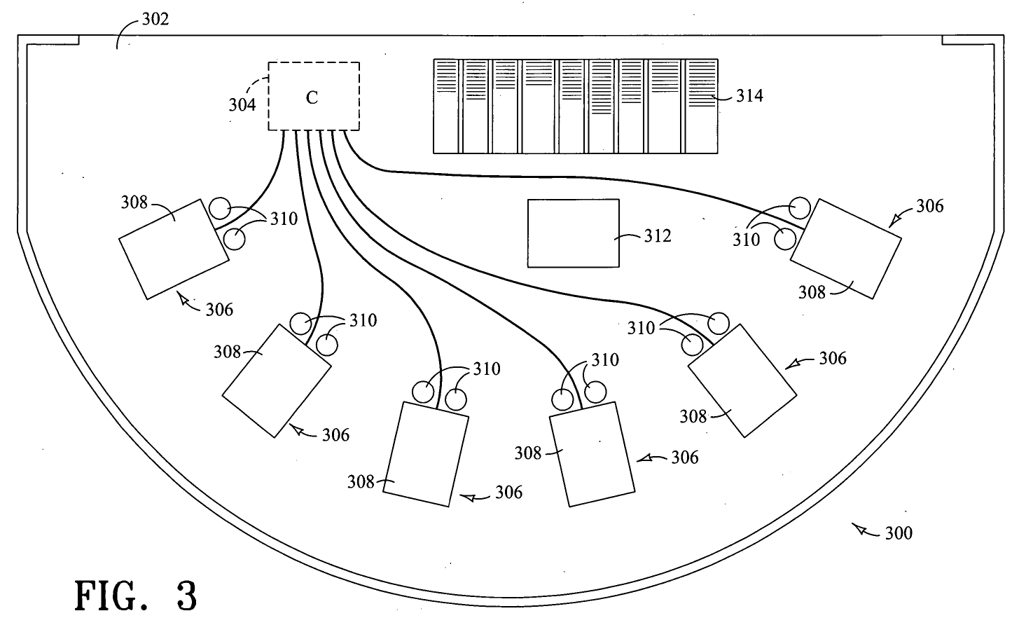

FIG. 3 is a plan view depicting a wager gaming table (hereafter, table) 300 in accordance with still another embodiment of the present invention. The wager gaming table 300, substantially as depicted in FIG. 3, is commercially available from DigiDeal Corporation of Spokane, Wash. The table 300 includes a playing surface 302. The playing surface 302 can be formed from any suitable material such as, for example, felt, satin, etc. Other materials can also be used to form the playing surface 302 of the table 300.

The table 300 also includes an electronic controller 304. The electronic controller 304 can be defined by any suitable controller usable to control the play one or more embodiments of the poker games of the present invention (e.g., the poker games of flowcharts 100 and 200 above, or their corresponding variations, respectively). As such, the controller 304 can be suitably defined by a microprocessor-based controller, a state-machine, a dedicated-purpose integrated controller, etc. The controller 304 is commercially available in the form of a proprietary (DCS) platform from DigiDeal Corporation of Spokane, Wash.

In one embodiment, the electronic controller 304 includes a computer-accessible storage media (i.e., memory, storage disk etc., not shown) including an executable program code. Such an executable program code (not shown) is configured to cause a corresponding processor to perform various operations in accordance with one or more embodiments of poker game of the present invention. One of skill in the computer engineering and electronic arts can appreciate that the electronic controller 304 can be defined by a number of suitable different embodiments and that further elaboration is not required for purposes of understanding the present invention.

The table 300 also includes a plurality of user interfaces 306. Each user interface 306 is coupled in signal communication with the electronic controller 304. Each user interface includes an electronic display 308 that is coupled in signal communication with the electronic controller 304. In the case of draw-poker type games, the electronic display 308 can be a touch-sensitive electronic display. Other embodiments of electronic display 308 can also be used. In any case, the electronic displays 308 are configured to display information to, and receive input from, a player during play of a poker game at the table 308. Non-limiting examples of such displayed information include images of playing cards, present amount of a collective pot, present amount of a jackpot and/or progressive jackpot, amount of credit available to the player, etc. Examples of player (i.e., user) input include selection of cards to discard during a draw, election to bet and/or fold, etc. Other kinds of information can be displayed, and other types of player input received, by way of the electronic display 308.

As further depicted in FIG. 3, each user interface 306 further includes one or more chip sensors 310. Each chip sensor 310 is configured to provide a signal to the electronic controller 304 indicative of the presence and/or total face value of any wagering chips (not shown) resting upon the chip sensor 310. One of skill in the electronic arts is aware of a number of suitable such embodiments of chip sensor 310 and further description is not needed for purposes herein.

In another embodiment of the table 300 (not shown), the chip sensors 310 are not included. In such an embodiment (not shown), “virtual” chips can be displayed to, and manipulated by (i.e., selected, put forth during a wager, etc.), players using associated electronic displays 308. Thus, in such an embodiment, tangible wagering chips are not used, and any antes and/or wagering corresponding to the play of the present poker game are handled by way of the electronic displays 308.

The table 300 can also includes a dealer display 312, although in many embodiments no dealer display is used. The dealer display 312 can be defined by any suitable electronic display for displaying information to a dealer (typically representing the house). In one embodiment, the display 312 is substantially the same as one of the plurality of electronic displays 308. Other forms of electronic display can also be used. In any event, the dealer display 312 is coupled in signal communication with the electronic controller 304 and is configured to display various information relevant to a dealer (typically representing the house) during play of the poker game at the table 300. Typical such information displayed on the dealer display 312 can include, for example, the amount of the various relevant collective pots and jackpots, identification of player at the table 300 in possession (i.e., holding) a qualifying or superior qualifying hand, etc. Information provided to the dealer can be presented, for example, in the form of an “ante meter”, a “wager meter”, etc., or as any other desirable graphical representation.

The table 300 further includes a chip tray 314. The chip tray 314 is configured to support a plurality of suitable wagering chips for use during play of the poker game at table 300. The chip tray 314 is generally positioned to be readily used by a dealer. A more elaborate description of the chip tray 314 is not necessary to an understanding of the present invention. In the variation described above wherein “virtual” chips can be used with the table 300 the chip tray can be eliminated.

Typical use of the table 300 is a follows: to begin, it is assumed that the house offers play of a poker game in accordance with the present invention (e.g., stud poker according to flowchart 100 of FIG. 1, or draw poker according to flowchart 200 of FIG. 2, etc.) to interested players by way of the table 300. Those players interested in playing the poker game generally seat themselves, one person each, within usable adjacency to the user interfaces 306. As depicted in FIG. 3, the table 300 can accommodate up to six players. Other tables 300 (not shown) having other player accommodation capacities can also be used.

Next, a dealer begins play of the poker game at the table 300 by way of appropriate input (i.e., password entry, startup actuation, etc.) to the controller 304 using dealer hands controls (such as buttons, etc., not shown) or, if provided, the dealer display 312. Thereafter, the controller 304 assumes general control of the game in substantial accordance with the methods described above in regard to the stud poker game of flowchart 100 of FIG. 1 or the draw poker game of flowchart 200 of FIG. 2, including, for example, providing graphical displays of cards, collective pots values, credit, etc., to each of the electronic displays 308 currently used by a player. In response, players provide their desired respective inputs directly to the dealer who can then input them into the electronic controller 304 (or, if a user input is provided, via their respective electronic displays 308). Such displays and player (user) inputs (if provided) are performed in accordance with the currently used embodiment of poker game of the present invention.

During such play, the players place their corresponding antes and wagers in the form of wagering chips on their respective chip sensors 310. These wagering chips are collected for the house by the dealer, generally into the chip tray 314, while the electronic controller 304 can keep track of (i.e., record) the ante pools, discrete wagers from each player, the rake (if any), the collective pot, a jackpot (if any), and/or any progressive jackpot, exchanges cards during a draw, etc. In various alternate configurations certain of these functions (e.g., keeping track of the ante pool) can be performed by a live dealer and not by the controller 304. Furthermore, the electronic controller 304 can indicate to the dealer and/or players (by way of the electronic displays 308 and/or dealer display 312) when a player or players is/are to be awarded the collective pot, jackpot, bad beat jackpot, and/or progressive jackpot corresponding to the poker game in progress.

Other operations can also be performed by the electronic controller 304 corresponding to the play and/or officiating of the current instance of the poker game of the present invention. For example, in an embodiment (not shown) of the table 300 in which tangible chips are not used, the electronic controller 304 receives antes and wagers, and awards the collective pot and/or any jackpots, through the use of virtual chips displayed and manipulated on the electronic displays 308. Still other operations of the electronic controller 304 can be performed. For example, the controller 304 can be used to provide audio output for informational purposes, enhancing excitement of the play of the game, or supplementing visual play of the game. In this way, the table 300 provides for play of one or more poker games (selectively), by two or more players, in accordance with the present invention and in a manner that is substantially automated by virtue of the electronic controller 304, the user interfaces 306 and the dealer display 312 (when provided).

It is to be understood that certain embodiments of the controller 304 can be linked in communication with a central computer or database (not shown) of the house so that information regarding the present status of the poker game in progress can be related to the central computer. Thus, for example, the current value of the collective pot, the total amount of credit in use, the current awarding of a jackpot, etc., for the table 300 can be recorded and/or verified for security purposes using the central computer (not shown).

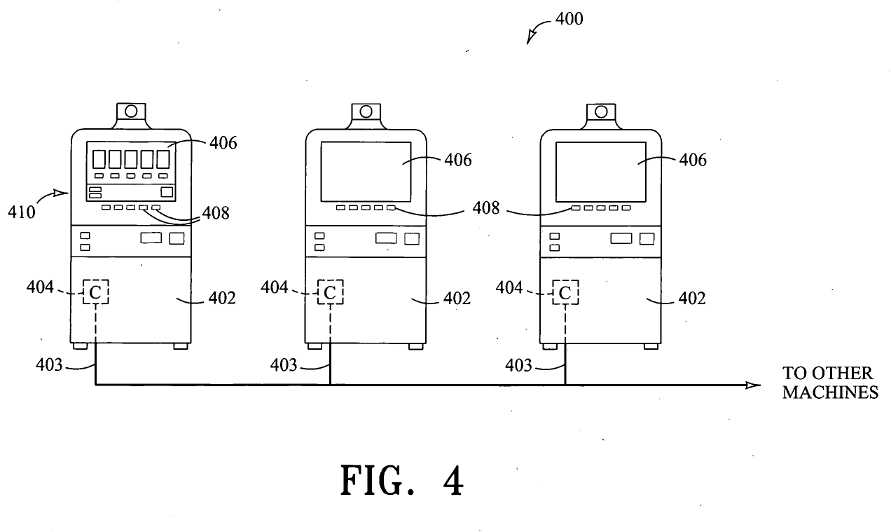

FIG. 4 is a front elevation view depicting a gaming network 400 in accordance with the yet another embodiment of the present invention. The gaming network 400 includes a plurality of individual gaming machines (hereafter, gaming machine) 402. Each gaming machine 402 includes an electronic controller 404. The electronic controller 404 can be defined by any suitable electronic controller usable to control the gaming machine 402 in accordance with the poker games of the present invention (e.g., the stud poker game of flowchart 100 of FIG. 1, the draw poker game of flowchart 200 of FIG. 2, etc.).

In one embodiment (not shown), the controller 404 includes a processor and a computer-accessible storage media including an executable program code. The executable program code (not shown) is configured to cause the processor to perform numerous operations in accordance with one or more embodiments of poker game according to the present invention. Other forms of electronic controller 404 can also be used. In any case, each of the electronic controllers 404 is configured to be coupled in mutual data communication thus defining a network of gaming machines 402. In this way, the electronic controllers 404 can communicate with each other so as to conduct a multi-player instance of a poker game of the present invention, wherein each player participates in the game by way of a respective gaming machine 402. Although the gaming machines are depicted as being directly connected to one another by communication cables 403, it is appreciated that the gaming tables can be placed in communication by other known means such as the Internet or other network configurations. In another embodiment (not shown), the individual gaming machines 402 are networked by way of wireless communication. Other embodiments can also be used.

Each gaming machine 402 also includes an electronic display 406. Each electronic display 406 is coupled in signal communication with the corresponding electronic controller 404 of the particular gaming machine 402. Each electronic display 406 can be defined by any suitable such electronic display configured to display various kinds of information in accordance with the present instance of a poker game of the present invention. Such displayed information can include, for example, images of playing cards, collective pot amount, present jackpot amounts, available credit, etc. Other information can also be displayed. Typically, each electronic display 406 is defined by a touch-sensitive electronic display such that each constitutes a user (player) interface to the respective electronic controller 404; Other forms of electronic display 406 can also be used, and other user input devices (such as buttons, keys, etc. not shown, can also be used.).

Each gaming machine can (optionally) include additional user interface controls 408. Controls 408 are typically provided in the form of pushbuttons. Other types of user interface controls 408 can also be used. The electronic display 406 and controls 408 are collectively referred to as a user interface 410 within a particular gaming machine 402.

Operation of the gaming network 400 is generally as follows: for purposes of example, it is initially assumed that all of the gaming machines 402 of the gaming network 400 are presently configured (selectively set) to play one embodiment (version, or type) of a poker game of the present invention, for example the draw poker game of the flowchart 200 of FIG. 2.

Next, each player deposits money into their respective gaming machine 402 so as to establish a corresponding amount of playable credit, referred to herein as prepaid credits. This can be done, for example, by way of a conventional currency acceptor (not shown) as is known in the art. The draw poker game in accordance with the present invention then commences once all players have secured their respective gaming credits.

Thereafter, the electronic controllers 404 operate in cooperation with each other and with their respective electronic displays 406 so as to carry out play of the current draw poker game. Generally, play is conducted as a succession of such draw poker games until at least one collective pot has been awarded. Furthermore, any applicable jackpots (bad beat, progressive, etc.) are also awarded during play under the control of the electronic controller(s) 404. Typically, individual players can exit (depart from) the game at any appropriate time of their choosing (e.g., at the beginning of the next game, after folding, etc.), while other (new) players can join at correspondingly appropriate times by way of associated gaming machines 402 of the gaming network 400.

Thus, the gaming network 400 is generally configured to provide for multi-user, substantially random-access (i.e., individually selected entry to and exit from) play of the poker games of the present invention. In another embodiment of the gaming network 400, each of the electronic controllers 404 is configured to permit a player to select from a menu of different poker games of the present invention (draw, stud, etc.) to play against other corresponding players within the same gaming network 400.

For example, a gaming network 400 (not shown) can be provided that includes twenty gaming machines 402, of which fourteen are presently being used to play a draw poker game of the present invention, while the remaining six are used to play a stud poker game of the present invention. Other possible such poker game playing combinations within a single gaming network 400 can also be performed.

In yet another embodiment, the controller 404 of each gaming machine 402 is configured to permit a player to selectively choose to play a poker game of the present invention in a solitaire or “individual play” mode. In such an embodiment, the player is effectively playing against the controller 404, and there is no interaction or competition against other players. Furthermore, such an embodiment (not shown) typically includes simultaneous display of both the player's cards and simulated opponent players cards. Other various embodiments of playing the poker games of the present invention can also be used.

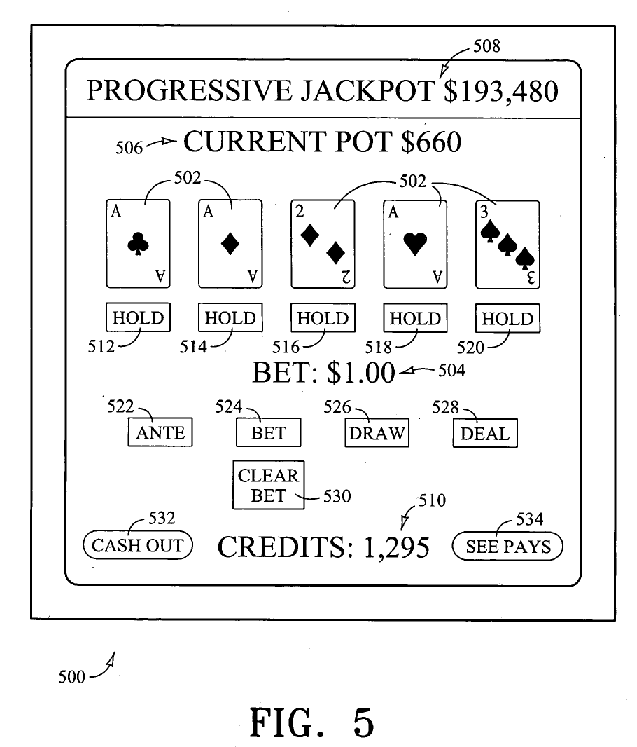

FIG. 5 is a front elevation view depicting an exemplary display 500 in accordance with still another embodiment of the present invention. The display 500 can be provided by way of the electronic displays 308 of FIG. 3, or the electronic displays 406 of FIG. 4. It is to be understood that the display 500 is intended to show exemplary details that are provided to a player during play of the poker games of the present invention, and that other details (not shown) can also be displayed. Alternatively, certain details as depicted in the display 500 of FIG. 5 can also be omitted in particular embodiments of the poker games of the present invention.

The display 500 includes a plurality of card images (hereafter, cards) 502. As depicted, a total of five cards 502 are provided. Other numbers of cards 502 can also be displayed. The display 500 also includes the present values of a bet (wager) 504, a collective pot 506, a progressive jackpot 508 and a prepaid credits 510 available to the player, respectively, which are defined substantially as described above in regard to the stud poker game of flowchart 100 of FIG. 1, the draw poker game of flowchart 200 of FIG. 2., and the gaming machines 402 of FIG. 4.

The display 500 also includes a plurality of controls 512 through 534, inclusive. As depicted in FIG. 5, it is assumed that the controls 512-534 are provided as interactive icons on a suitable touch-sensitive electronic display (e.g., the electronic displays 308 of FIG. 3). In this way, a player activates a particular control 512-534 simply by touching their finger (or a stylus, etc.) generally on that area of the electronic display occupied by the particular control 512-534. Each of the controls 512-534 provides for player actuation of a certain operation or function as indicated by the indicia and/or form of the control 512-534.

For example, a HOLD control 514 permits a player to select and retain the card 502 adjacent to the HOLD control 514 during an election to draw cards 502 while playing a draw version of the poker games of the present invention (e.g., the flowchart 200 of FIG. 2). Once a player's selection of retained cards 502 is made via the corresponding HOLD controls 514-520, a DRAW control 526 is used to signal the associated electronic controller (not shown—see the electronic controller 304 of FIG. 3) that the player is ready to draw (exchange) those non-held cards with the house. Other exemplary operations of other controls 512-534 can also be performed.

In certain embodiments of the present invention, particular of the (interactive icon) controls 512-534 can be associated with other forms of controls provided to a player. For example, each of the HOLD controls 512-520 can be associated with a respective pushbutton control 408 of a gaming machine 402 of FIG. 4. Thus, under such an embodiment, a player can have two (or more) ways in which to actuate a given operation or to make a particular selection during play of a poker game of the present invention.

In another embodiment (not shown), the display 500 can also include meters (not shown) relating game play information regarding, for example: the number of hands (games) played by the player or players thus far; the frequency at which qualifying hands have occurred, resulting in the awarding of the collective pot (i.e., average number of games or hands per win); the frequency at which applicable jackpots or progressive jackpots have been awarded; etc. Such displays of information (meters) can include any suitable graphics and/or indicia and generally tend to stimulate player interest in relatively long-term play of the poker game.

Another embodiment of the present invention provides a gaming table for the play of at least one of the poker games of the present invention. The gaming table includes a plurality of user interfaces. The gaming table also includes an electronic controller coupled in signal communication with each of the user interfaces. Such a gaming table is described in regard to the table 300 of FIG. 3, which includes the electronic controller 304 and the plurality of user interfaces 306. The electronic controller is configured to define a qualifying hand, and to deal an initial hand of at least one card to each of at least two players by way of the user interface corresponding to the player. The electronic controller is also configured to record an initial bet into a collective pot, from each of at least one of the players, by way of the corresponding user interface. The electronic controller is further configured deal at least one later card to each betting player by way of the corresponding user interface.

Furthermore, the electronic controller is also configured to award the collective pot to any betting player who has a best hand that comprises a qualifying hand. In the event that no player has a qualifying hand, the electronic controller is also configured to repeat the dealing an initial hand and the recording an initial bet and the dealing at least one later card until at least one player has a qualifying hand and the collective pot is awarded.

Another embodiment of the present invention provides an electronic controller including a computer-accessible storage media. The computer-accessible storage media includes an executable program code. The executable program code can be configured to cause a corresponding processor to perform the steps recited above in regard to the electronic controller of the gaming table, as well various of the steps described hereafter. Thus, such an electronic controller can be used in conjunction with the gaming table or other suitable apparatus of the present invention.

One variation of the electronic controller of the gaming table is configured to exchange a respectively selected number of cards between the electronic controller and each betting player electing to draw, by way of the corresponding user interface, during the dealing of at least one additional card. Another variation of the electronic controller is configured to record an additional bet into the collective pot from each betting player, by way of the corresponding user interface, before the dealing of at least one later card to each betting player. In still another variation, the electronic controller is configured to record an ante from each of the least two players by way of the corresponding user interface, before dealing the initial hand.

Other respective variations of the electronic controller of the gaming table described above can also be provided. In one such variation, the electronic controller is configured to add a predefined portion of a sum of the antes to a progressive jackpot, and then to award the progressive jackpot (or, a fixed jackpot) to an anteing player upon achieving a corresponding predefined (jackpot) hand. In another variation, the electronic controller is configured to extract a rake from the collective pot for a house. In still another variation, the electronic controller is configured to extract a predefined fixed amount from the collective pot for a house. In yet another variation, the electronic controller is configured such that the initial hand and the at least one later card are dealt in a face-up condition, respectively.

The present invention further provides for an individual gaming machine. The individual gaming machine includes a user interface, and an electronic controller. Such an individual gaming machine is described above in regard to the individual gaming machines 402 of FIG. 4, each of which includes a user interface 410 and an electronic controller 404. The electronic controller of the individual gaming machine is coupled in signal communication with the user interface, and is configured to be coupled in signal communication with at least one other electronic controller of another individual gaming machine.

In this way, a cooperative network (i.e., plurality) of such individual gaming machines can be defined. The electronic controller of each individual gaming machine is configured to perform selective of the steps described above in regard to the electronic controller of the gaming table, substantially as described. Thus, various embodiments of the individual gaming machine of the present invention can be defined.

In yet another embodiment the present invention provides for a method of playing a card game of chance wherein one or more players are each dealt an initial hand comprising at least one card. A bet (either an initial bet or a side bet) is accepted from at least one of the players and is added to a pot. A secondary chance activity is then performed (such as dealing another card to one or more of the players, or exchanging at least one card with one or more of the players, or turning a card from a face-down position to a face-up position). Following the secondary chance activity a determination is made if one or more of the players has a hand meeting a predefined criteria. If so, the pot is awarded to that player. If not, the pot is maintained as a collective pot, and the game is repeated until a player has a hand which meets the predefined criteria, at which time the collective pot is awarded to that player. Non-limiting examples of card games of chance to which this method can be applied include blackjack, poker (all variations), slot-jack, etc.

In a further embodiment the present invention provides for a method of playing an electronic game of chance wherein one or more players are each provided (by way of an electronic display) an initial image set comprising one or more virtual images (such as cards, slot machine-type images (cherries, lemons, etc), “blanked” images (i.e., an obscured image) or other images which can be mixed and matches with one another to thereby define a winning set of images. A bet (either an initial bet or a side bet) is accepted from at least one of the players and is added to a pot. A secondary chance activity is then performed (such as providing another virtual image to one or more of the players, or exchanging at least one previously provided virtual image card with one or more of the players, or uncovering a “blanked” virtual image. Following the secondary chance activity a determination is made if one or more of the players has an image set meeting a predefined criteria. If so, the pot is awarded to that player. If not, the pot is maintained as a collective pot, and the game is repeated until a player has an image set which meets the predefined criteria, at which time the collective pot is awarded to that player.

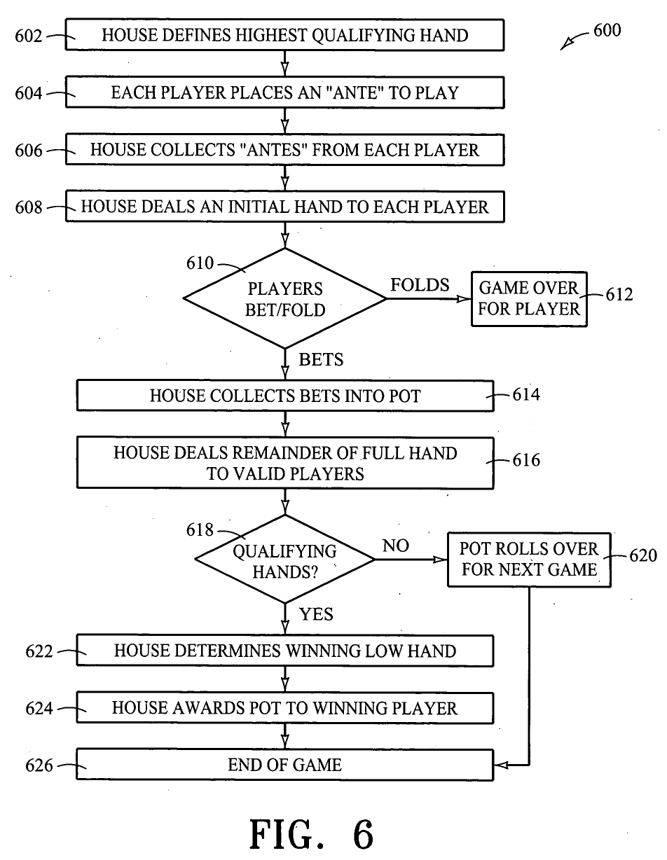

FIG. 6 is a flowchart 600 depicting a method for playing a poker game in accordance with another embodiment of the present invention. The embodiment described in the method depicted by flowchart 600 is generally considered a “lo-ball” version of the poker game of the present invention. While the method depicted by flowchart 600 describes particular steps and order of execution, it is to be understood that other embodiments of the present invention that respectively include other steps and/or orders of execution can also be used in accordance with the teaching of the present invention.

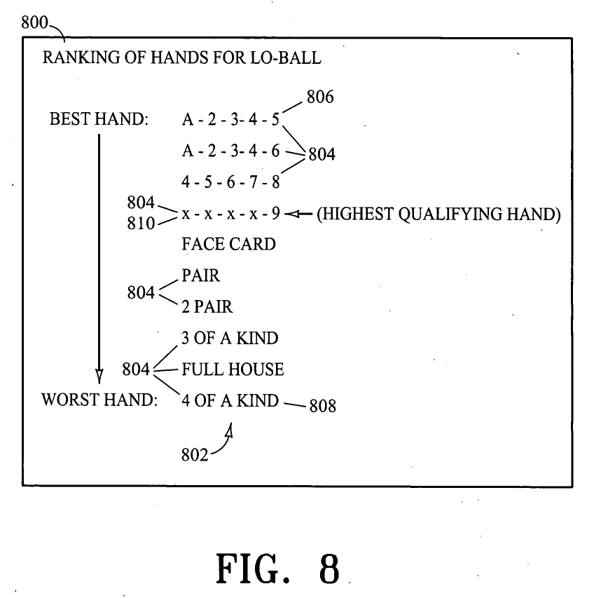

In step 602 of flowchart 600, the house defines a highest qualifying hand for play of the lo-ball poker game. The qualifying hand is generally considered a maximum hand necessary for a player to qualify for winning a pot (described hereafter). The qualifying hand is ranked relative to other hands in accordance with rules for playing lo-ball poker. One possible hierarchy (i.e., ranking) of such hands is described in further detail hereinafter in regard to the table 800 of FIG. 8. The qualifying hand can be defined, for example, to be any hand including no card content greater than a single nine. In another example, the qualifying hand is defined by any hand including no content greater than a pair. Other qualifying hands can also be defined and used, for example, in accordance with a consensus of the player(s) prior to the beginning of the poker game. For purposes of present example, it is assumed that the qualifying hand is defined by the house to be any hand including no card content greater than a single ten. Further, the house can define a minimum card value for a player to be eligible to continue to play. For example, the house can require a player to have an ace or a two (ace being the lowest card in lo-ball) in order for a player to be eligible to continue to play of the game.

In step 604, each of one or more players places (i.e., puts forth) an ante so as to establish their initial participation in the game about to commence. Generally, the ante is a fixed amount of money predefined by the house. All of the antes put forth by the players can be collectively considered an ante pool.

In step 606, the house gathers the ante pool as its share for hosting, or officiating, the present game.

In step 608, the house deals an initial hand of one or more cards—in accordance with the present embodiment of lo-ball poker game being played—in a face-up condition to each of the players participating in the game (i.e., those players that anted in step 604 above; also considered valid players for purposes herein). For purposes of ongoing example, it is assumed that an initial hand of two cards is dealt to each valid player and that a full hand constitutes five cards total for the present embodiment of the game. Other card counts respectively corresponding to other initial hands and full hands can also be used. Further, it is assumed that cards used during play are dealt from a standard (fifty-two card) poker deck or its equivalent, or multiple decks. Further still, the two standard jokers (wild cards) can also be used.

In step 610, each player decides if they are to continue the game, or quit at this point without further play of the present game. Those players who elect to quit, or “fold” continue to step 612 below. Those players that elect to continue play continue to step 614 below.

In step 612, those players electing to quit in step 610 above, do so. The present instance of the lo-ball game of flowchart 600 is now ended for those players. However, players that fold at this point are eligible to continue play in the next (sequential) game and can therefore continue to compete with other players for a collective pot (described hereafter), should it not be awarded to a player or players at the end of any current round of the poker game.

In step 614, each player that elected to continue play in step 610 above now places a respective wager, or bet, into a collective pot. It is to be understood that each of the wagers is of a minimum equivalent value, and is typically predefined by the house as a minimum bet or wager. The amount of the minimum bet can be fixed for all instances of playing the game, or can change from time to time. In another embodiment of the game, for example, the amount of the bet escalates (increases) in value with each successive instance of playing the poker game. Other strategies of establishing the minimum bet can also be used.

In any case, the bet or bets from the player or players are placed into a collective pot that includes any residual bet or bets not yet awarded to a player or players from previous play(s) of the lo-ball poker game of flowchart 600. In another embodiment, the house takes a rake (or a percentage) out of the collective pot at this time, once betting following the dealing of the initial hand in step 608 is complete. It is to be understood that the betting players place their respective bets in a near simultaneous fashion. In this way, the substantially traditional system of call/check/raise is typically not applicable to one or more embodiments of the lo-ball poker game of the present invention, although such check/call/raise features are not necessarily precluded from all lo-ball poker games of the present invention. Thus, the lo-ball poker game of flowchart 600 results in a generally faster sequence of play relative to that of generally traditional poker. Furthermore, betting is typically performed in equal amounts within each round of a poker game of the present invention.

In step 616, the house deals one or more additional cards in a face-up condition to each of the presently valid (i.e., betting) players, such that each valid player now has a full hand (i.e., a card count constituting a complete hand). For purposes of the present example, it is assumed that each valid player now has a total of five cards.

In step 618, the house determines if any of the valid players has a qualifying (final) hand in accordance with the highest qualifying hand defined above in step 602. If one or more players have a qualifying hand, then the flowchart 600 proceeds to step 622 below. If none of the players has a qualifying hand, then the flowchart 600 proceeds to step 620 below.

In step 620, the house sets the present (collective) pot aside for use in the next instance of playing the game. In this way, the pot can be considered a “progressive” pot. The flowchart 600 then proceeds to step 626 in which the present instance of the poker game is ended without awarding any portion of the pot to any player or players. The present instance (iteration) of the poker game provided by flowchart 800 is considered complete.

In step 622, the house evaluates and compares any qualifying hands held by one or more of the players in accordance with predefined hierarchical rules of lo-ball poker, to determine which hand is a lowest (or “best”) qualifying hand, or if equivalent lowest qualifying hands are held by two or more players.

In step 624, the house awards the collective pot to a single player (winner) holding the lowest qualifying hand as determined in step 622 above. If two (or more) players hold equivalent lowest qualifying hands, then the collective pot can be equally split between them.

In step 626, the present instance of the lo-ball poker game is considered complete. If the collective pot has not been awarded during the most recent instance of the game, the lo-ball poker game of the flowchart 600 is typically repeated, as one or more additional instances of the poker game, until the collective pot is finally awarded to one or more of the present players.

The flowchart 600 as described above generally provides for one possible embodiment of playing a game of lo-ball poker in accordance with the present invention. Other embodiments corresponding to other steps, procedures and/or orders of execution can also be used. It is important to note that one or more aspects of the game depicted by the flowchart 600 can be suitably varied, typically by the house and/or in accordance with player agreement. For example, the ante put forth by the players in step 604 above can be either fixed or varying. Such a varying ante can be defined by an escalating ante that increases with each successive instance of playing the lo-ball poker game of flowchart 600. Such a varying (e.g., escalating) ante is desirable to the house as it usually corresponds to higher earnings or profits in exchange for hosting the game. Other forms of varying ante can also be used.

Furthermore, certain embodiments of the lo-ball poker game of the present invention can also include a jackpot or a progressive (i.e., accumulating) jackpot that is awarded to a player that holds a correspondingly predefined hand (for example, during step 624 above). For example, a progressive jackpot can be awarded to a player whose final hand constitutes ace-two-three-four-five (generally referred to as a five-four hand or “wheel”). In another example, a jackpot can be awarded to a player whose final hand constitutes ace-two-three-four-six, or less (generally referred to as a six-four hand). Other types of jackpots can be awarded for correspondingly predefined hands.

Typically, the amount of a progressive jackpot is increased by way of adding a portion from each of the antes (e.g., the ante pool) put forth by the players during each game (for example, as in step 604 above). This strategy can be attractive to both the players and the house, as the house can charge an incrementally higher ante while providing the progressive jackpot as an inducement to the players of the lo-ball poker game. Conversely, a jackpot can be provided as a fixed value, house-funded incentive with no apparent bearing on a player's antes or wagers. Other jackpot or progressive jackpot schemes can also be used.

In yet another embodiment of the stud poker game of flowchart 600, any player electing to ‘sit out’ for a hand (not participate) in the present instance of the game forfeits their option to continue playing toward the present collective pot. Thus, under such an embodiment, the collective pot at hand is particular to the specific player or players whose poker play resulting in the creation and perpetuation of the present collective pot, and such collective pot will not be awarded to another player or other players.

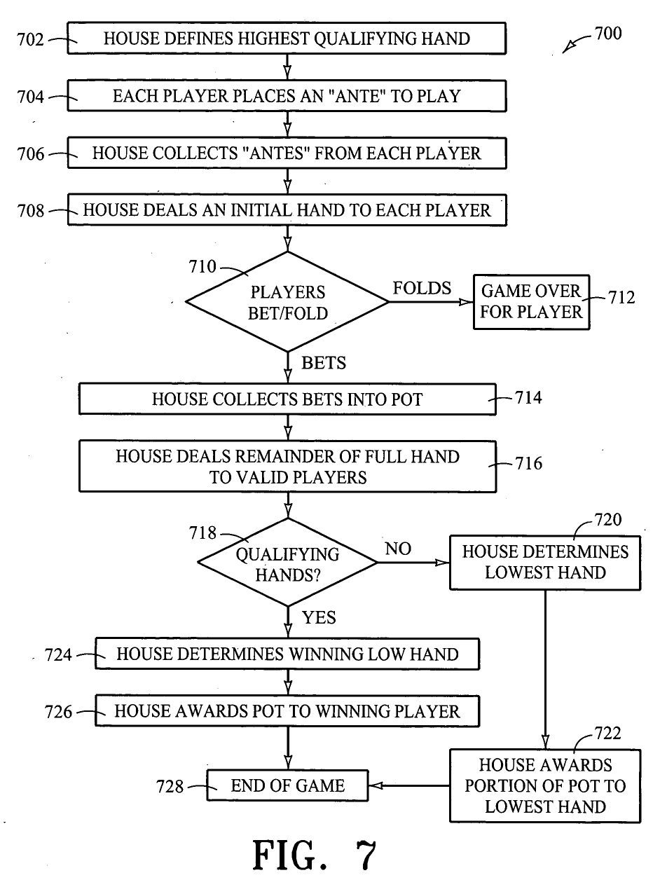

FIG. 7 is a flowchart 700 depicting a method for playing a lo-ball poker game in accordance with another embodiment of the present invention. While the method depicted by flowchart 700 describes particular steps and order of execution, it is to be understood that other embodiments of the present invention that respectively include other steps and/or orders of execution can also be used in accordance with the teaching of the present invention.

In step 702 of flowchart 700, the house defines a highest qualifying hand for play of the present lo-ball poker game. The qualifying hand is generally defined in the same manner as described above with respect to step 602 of the flowchart 600 of FIG. 6. Thus, one possible hierarchy or ranking of such hands is described hereinafter in regard to FIG. 8. For purposes of present example, it is assumed that the qualifying hand is defined by the house to be any hand including no content greater than a single nine. Further, as described above with respect to FIG. 6, the house can define a minimum card value for a player to be eligible to continue to play.

In step 704, each of one or more players places (i.e., puts forth) an ante so as to establish their initial participation in the game about to start. Generally, such an ante is a fixed amount of money predefined by the house. All of the antes can be collectively considered an ante pool.

In step 706, the house gathers the ante pool as its share for hosting, or officiating, the present game.

In step 708, the house deals an initial hand of one or more cards in a face-up condition to each of the players participating in (i.e., anted into) the present game (also considered valid players for purposes herein). For purposes of further example, it is assumed that an initial hand of three cards is dealt to each valid player and that a full hand constitutes five cards total for the present embodiment of the game. Other card counts respectively corresponding to other initial hands and full hands can also be used. Further, it is assumed that cards used during play are dealt from a standard (fifty two card) poker deck or its equivalent, or multiple decks. Also, the two standard jokers (wild cards) can also be used.

In step 710, each player decides if they are to continue the game, or quit at this point without further play of the present game. Those players who elect to quit, or ‘fold’ continue to step 712 below. Those players that elect to continue play continue to step 714 below.

In step 712, those players electing to quit in step 710 above, do so. The present instance of the lo-ball game of flowchart 700 is now ended for those players. However, such quitting players are generally eligible to continue play in the next (sequential) game and can therefore continue to compete with other players for at least some portion of a same collective pot (described hereafter), should it not be awarded at the end of the current lo-ball poker game.

In step 714, each player that elected to continue play in step 710 above now places a respective wager, or bet, into a collective pot. It is to be understood that each of the wagers is of a minimum equivalent value, and is typically predefined by the house as a minimum bet or wager. The amount of the minimum bet can be fixed, or can change from time to time. In another embodiment of the game, for example, the amount of the bet escalates (increases) in value with each successive instance of playing the poker game. Other strategies of establishing the minimum bet can also be used.

In any case, the bet or bets from the player or players are placed into a collective pot that includes any residual bet or bets, or portions of a previous pot or pots, not yet awarded to a player or players from previous play(s) of the lo-ball poker game of flowchart 700. In another embodiment, the house takes a rake or percentage out of the collective pot at this time, once betting following the dealing of the initial hand in step 708 is done. Furthermore, betting players place their respective bets in a near simultaneous fashion. In this way, the typical traditional system of call/check/raise is generally not used in accordance with one or more embodiments of the lo-ball poker game as depicted by flowchart 700 of FIG. 7, although such check/call/raise features are not necessarily precluded from all lo-ball poker games of the present invention. Thus, the lo-ball poker game of flowchart 700 results in a generally faster sequence of play relative to that of generally traditional poker. Furthermore, betting is typically performed in equal amounts within each round of a poker game of the present invention.

In step 716, the house deals one or more additional cards in a face-up condition to each of the presently valid (i.e., betting) players, such that each valid player now has a full hand (i.e., a card count constituting a complete hand). For purposes of the present example, it is assumed that each valid player now has a total of five cards.

In step 718, the house determines if any of the valid players has a qualifying (final) hand in accordance with the highest qualifying hand defined above in step 702 (e.g., a hand including no content greater than a single nine). If one or more players have a qualifying hand, then the flowchart 700 proceeds to step 724 below. If none of the players has a qualifying hand, then the flowchart 700 proceeds to step 720 below.

In step 720, the house determines which one of the valid (betting) players has the lowest hand that is not a qualifying hand. The house makes this determination in accordance with the predefined ranking of lo-ball poker hands applicable to the present embodiment of the game (for example, the hierarchy depicted in table 800 of FIG. 8). If two or more valid players hold equivalent lowest non-qualifying hands, the house identifies such two or more players at this time.

In step 722, the house awards a predetermined portion of the collective pot to that player having the lowest non-qualifying hand as determined in step 720 above. In one embodiment, for example, the house awards twenty percent (20%) of the pot to the player identified in step 720. In another exemplary embodiment, the house awards a fixed amount (e.g., ten dollars, etc.) to the player with the lowest non-qualifying hand. The particular amount of the awarded portion can be predetermined in any suitable manner. Furthermore, if two or more players are determined to have equivalent lowest non-qualifying hands, the portion awarded normally awarded to a single such player can be evenly divided between them. Other portion sharing schemes can also be used. In any case, after such a portion of the pot is awarded, the flowchart proceeds to step 728 below.

It will be appreciated that the method described with respect to step 722 (i.e., of awarding a predetermined portion of the collective pot to a player having a lowest non-qualifying hand) can be applied to any of the poker games described herein, and not just the lo-ball poker game of the present example. That is, for any of the poker games described herein, one of the features can be that, in the event there is no qualifying hand, a portion of the pot is awarded to the player having the “best non-qualifying hand”. For example, in a traditional “high-hand” poker game wherein a winning hand (“best qualifying hand”) is based on combinations (e.g., two or more of a kind, flush, straight, etc.), then in the event no player has a winning hand, a portion of the pot can be awarded to a player identified as having a high card count in his/her hand (“best non-qualifying hand”). In this instance, a “high card count” is determined by identifying the hand having the highest card. If two or more hands have high cards of equal value, then determination of the “high card count” looks to the second highest card in each player's hand, and so on until one player has a higher value card in his/her hand than any other player. In the event of a tie, the portion of the pot to be awarded can be divided among those players having equivalent “high card count” hands. Similarly, in a lo-ball poker game wherein a winning hand (“best qualifying hand”) is based on lack of combinations (e.g., two or more of a kind, etc.), then in the event no player has a winning hand, a portion of the pot can be awarded to a player having the low card count in his/her hand (“best non-qualifying hand”). In this instance, a “low card count” can be determined by identifying the hand having the least combination, or the lowest high card. For example, in a “top-down” approach, if one player has a jack in his/her hand as the highest card, and another player has a king in his/her hand as the highest card, then the player holding the jack has the “low card count” between the two players. In another example, if one player has three-of-a-kind in his/her hand, and another player has two-of-a-kind in his/her hand, then the player holding the two-of-a-kind has the “low card count” between the two players. If two or more players have minimum high cards of equal value in their hands (e.g., two players have a jack in their hand, and no other player has a lower high card), then determination of the “low card count” can look to the second lowest highest card in each players hand, and so on until one player has a lower value card in his/her hand than any other player. Alternately, the “low card count” can be based on a “bottom-up” approach. For example, if one player has a four in his/her hand as the lowest overall card, and another player has a five in his/her hand as the lowest overall card, then the player holding the four has the “low card count” between the two players. In the lo-ball embodiment, in the event of a tie for “low card count” hands between players, the portion of the pot to be awarded can be divided among those players having equivalent “low card count” hands. It will be appreciated that, in any instance (“high-hand”, “lo-ball”, or any other variation of poker), the determination of what constitutes a “best non-qualifying hand” can be defined by the house and promulgated to the players.

Continuing with the flowchart 700 of FIG. 7, in step 724, the house determines which of the valid players has the lowest (best) qualifying hand. If two (or more) players hold equivalent lowest qualifying hands then the house identifies these two or more players accordingly.

In step 726, the house awards the entirety of the present pot to the player holding the lowest (i.e., best) qualifying hand as determined in step 724 above. In the event that two or more players were determined to have equivalent lowest qualifying hands, then the entirety of the pot can be evenly divided between them. Other pot sharing schemes can also be used.

In step 728, the present instance of the lo-ball poker game according to the flowchart 700 is considered complete. If only a portion of the collective pot was awarded during the most recent instance of the game, the lo-ball poker game of the flowchart 700 is typically repeated, as one or more additional instances of the poker game, until the entirety of the then-present collective pot is finally awarded to one or more of the present players.

It is to be understood that the flowchart 700 as described above generally provides for another possible embodiment of playing a game of lo-ball poker in accordance with the present invention. Other embodiments corresponding to other steps, procedures and/or orders of execution can also be used. One or more aspects of the game depicted by the flowchart 700 can be suitably varied, typically by the house and/or in accordance with player agreement. Such variations can be directed to, for example: fixed, varying or escalating antes; a jackpot and/or progressive jackpot scheme; sit-out and forfeiture of the present (collective) pot or future portions thereof; or other aspect of a game of lo-ball poker substantially as described above in regard to the embodiment of lo-ball poker depicted by the flowchart 600 of FIG. 6.

In this manner, numerous differing embodiments of (i.e., variation on) the lo-ball poker game depicted by the flowchart 700 of FIG. 7 can be defined and used (played). One characteristic particular to the lo-ball poker game(s) of the flowchart 700 is the awarding of a portion of the pot to a player (or players) with the lowest hand that does not comprise a qualifying hand (as in step 722 of FIG. 7, for example). Such embodiments of lo-ball poker can be directed to, for example, compliance with state or other applicable gaming regulations that require the awarding of a prize or payoff (i.e., a portion of the pot) to at least one player during each iteration or instance of the game. In another circumstance, a similar “portion of the pot” scheme is used as a player incentive. Other reasoning or strategies for playing the game of lo-ball poker as generally depicted by the flowchart 700 of FIG. 7 can also be used.

It will be further appreciated that the method described with respect to step 722 above (i.e., of awarding a predetermined portion of the collective pot to a player having a lowest non-qualifying hand) can be applied to any game of chance wherein a roll-over pot is created such that the pot “rolls-over” to the next event of play (e.g., the next hand in games wherein hands of cards are dealt) should no player meet the qualifications for winning the pot. This method is particularly applicable to games of chance wherein a house hosts a multi-player game and the players play against one another, and not against the house. Accordingly, the method can generally be described as follows: a house hosts a multi-player, player-versus-player game; the house optionally collects an ante from each player wishing to engage in the game (the “active players”), and the ante is typically kept by the house; the players place a bet which is added to a pot; the house provides the active players the cards or other media, in electronic for tangible form, from which the individual players will each determine whether to continue play or not; the house will provide those players wishing to continue with one or more additional cards or media, typically in a sequential manner, and players will be able to continue play or discontinue play depending on their present position, placing additional bets to be added to the pot as play continues; once all cards or media have been provided to the players in accordance with the rules of the game, any player having a winning position (as determined from pre-defined rules) will win the pot; if no player meets the qualifications for winning the pot (i.e., has a winning position), then one or more of the remaining active players are awarded a portion of the pot according to predetermined rules, and the remainder of the pots “rolls over” to the next event of play.

FIG. 8 is a table 800 depicting a hierarchical ranking of lo-ball poker hands in accordance with the respective embodiments of the present invention depicted in FIGS. 6 and 7. It is to be understood that the table 800 depicts but one possible ranking of lo-ball poker hands usable in accordance with the present invention. Other hierarchical rankings corresponding to other embodiments of the present invention can also be used.

The table 800 includes a listing 802. The listing 802 includes a number of five-card hands 804. Each of the hands 804 depicts or describes the particular card-wise composition for that hand 804. As depicted in FIG. 8, a best hand 804 is further designated as lowest hand 806. The lowest hand 806 includes the cards ace-two-three-four-five, of any respective matching and/or differing suits. Hence, as depicted in the table 800 of FIG. 8, flushes and straights are generally irrelevant. Also, as depicted in FIG. 8, an ace is of the lowest value of all individual cards within a standard fifty-two card poker deck, while a king is of the highest value. The lowest hand 806 is further referred to as a five-four hand or “wheel”.

The table 800 also includes a worst hand 804, which is further designated as highest hand 808. The highest hand 808 consists of four-of-a-kind. Thus, the lowest hand 806 and the highest hand 808 are considered to define opposite ends of the listing 802 of the table 800. Other hands 804 are depicted in respective rank order between the lowest (best) hand 806 and the highest (worst) hand 808 within the listing 802.

Further included in the table 800 is an exemplary highest qualifying hand (hereafter, qualifying hand) 810. As depicted in FIG. 8, the highest qualifying hand 810 is defined by any hand including a single “nine” card, as well as four additional cards (“X-X-X-X”), wherein the four additional cards are each less than nine, and are different from one another. Therefore, any hand including a card or combination of cards ranked greater (i.e., higher) than a single nine would be a non-qualifying hand within a lo-ball poker game of the present invention corresponding to the table 800. For example, any hand including a face card would be a non-qualifying hand, and so on. It is to be understood that in another embodiment (not shown) of the table 800 a different hand 804 can be designated as the highest qualifying hand (for example, any hand including a pair or higher, etc.). Thus, in the present example a qualifying hand includes no card higher than a nine, and no combinations of a pair or better. (Recall that straights and flushes do not count towards betterment or disqualification of a hand in lo-ball poker.)

In this way, the table 800 of FIG. 8 defines one possible ranking scheme of five-card hands 804 for use in accordance with the lo-ball poker games of the present invention (e.g., as depicted by flowcharts 600 and 700 of FIGS. 6 and 7, respectively). It is to be understood that the table 800 does not exhaustively depict the ranking of all possible hands that can occur within a lo-ball poker game under the present invention. For example, a five-card hand comprised of the cards nine-eight-seven-six-three would rank higher (worse) than the hand 804 of ace-two-three-four-six, but less (better) than the hand 804 of nine-eight-seven-six-four. As a general rule, the lower the rank of each of the individual cards within a hand—without forming pairs or triplets, etc.—the lower or “better” the hand. As stated above, straights and flushes are typically irrelevant within the various lo-ball poker games of the present invention.

While the above methods and apparatus have been described in language more or less specific as to structural and methodical features, it is to be understood, however, that they are not limited to the specific features shown and described, since the means herein disclosed comprise preferred forms of putting the invention into effect. The methods and apparatus are, therefore, claimed in any of their forms or modifications within the proper scope of the appended claims appropriately interpreted in accordance with the doctrine of equivalents.

1. A method of playing a poker game, comprising:
defining a qualifying hand;
dealing an initial hand of at least one card to each of one or more players;
accepting a bet into a pot from at least one of the players; and
awarding the pot to any betting player who has a lowest hand that comprises a qualifying hand, or, if no player has a qualifying hand, repeating the dealing an initial hand and the accepting a bet, and including in the pot at least a portion of any previously unawarded pot or pots until the pot is awarded.

2. The method of claim 1, and further comprising, if no player has a qualifying hand, awarding a predetermined portion of the pot to any betting player who has a lowest hand that does not comprise a qualifying hand.

3. The method of claim 1, wherein:
the qualifying hand is further defined by a highest qualifying hand; and
the highest qualifying hand is defined by a house.

4. The method of claim 1, and further comprising dealing at least one additional card to each betting player after the accepting a bet.

5. The method of claim 1, wherein the lowest hand that comprises a qualifying hand is determined in accordance with a predetermined ranking of poker hands.

6. The method of claim 1, and further comprising exchanging at least one card between a house and each betting player electing to draw after the accepting a bet.

7. The method of claim 1, wherein the bet is predefined as a minimum bet.

8. The method of claim 1, and further comprising extracting a predefined percentage out of the pot by a house each time the initial hand is dealt.

9. The method of claim 1, and further comprising extracting a rake out of the pot by a house each time the initial hand is dealt.

10. The method claim 1, wherein at least one of the players plays the poker game by way of an individual gaming machine.

11. The method of claim 1, wherein:
at least two players play the poker game by way of respective individual gaming machines; and
each of the individual gaming machines are coupled in signal communication.

12. The method of claim 1, and further comprising:
collecting an ante from each player before the initial hand is dealt;
extracting a predefined portion from a sum of the antes;
adding the predefined portion to a progressive jackpot; and
awarding at least a portion of the progressive jackpot to a player achieving a corresponding predefined hand.

13. The method of claim 4, wherein the initial hand and the at least one additional card are respectively dealt in a face-up condition.

14. The method of claim 1, wherein at least two players play the poker game by way of an electronic gaming table.

15. A gaming table, comprising:
a plurality of user interfaces; and
an electronic controller coupled in signal communication with each of the user interfaces, the electronic controller configured to:
define a qualifying hand;
deal an initial hand of at least one card to each of at least two players by way of the user interface corresponding to the player;
record a bet into a pot from each of at least one of the players by way of the corresponding user interface;
deal at least one later card to each of one or more betting players by way of the corresponding user interface; and
award the pot to any betting player who has a lowest hand that comprises a qualifying hand by way of the corresponding user interface, or, if no player has a qualifying hand, repeat the dealing an initial hand and the recording a bet and the dealing at least one later card, and including in the pot at least a portion of any previously unawarded pot or pots until the pot is awarded.

16. The gaming table of claim 15, wherein the electronic controller is further configured to award a predetermined portion of the pot to any betting player who has a lowest hand that does not comprise a qualifying hand by way of the corresponding user interface, if no player has a qualifying hand.

17. The gaming table of claim 15, wherein the electronic controller is further configured such that dealing the at least one later card to each of one or more betting players is defined by exchanging a respectively selected number of cards between the electronic controller and each betting player electing to draw by way of the corresponding user interface.

18. The gaming table of claim 15, wherein the electronic controller is further configured to record an additional bet into the pot from each betting player by way of the corresponding user interface before dealing the at least one later card to each of one or more betting players.

19. The gaming table of claim 15, wherein the electronic controller is further configured to record an ante from each of the at least two players by way of the corresponding user interface before dealing the initial hand.

20. The gaming table of claim 19, wherein the electronic controller is further configured to:
add a predefined portion of a sum of the antes to a progressive jackpot; and
award at least a portion of the progressive jackpot to an anteing player achieving a corresponding predefined hand by way of the corresponding user interface.

21. The gaming table of claim 15, wherein the electronic controller is further configured to extract a rake from the pot for a house.

22. The gaming table of claim 15, wherein the electronic controller is further configured to extract a predefined fixed amount from the pot for a house.

23. The gaming table of claim 15, wherein the electronic controller is further configured such that the initial hand and the at least one later card are respectively dealt in a face-up condition.

24. The gaming table of claim 15, wherein each of the user interfaces comprise a display screen configured to display graphical images of the cards.

25. The gaming table of claim 15, wherein each of the user interfaces further comprise a chip sensor.

26. The gaming table of claim 15, and further comprising a display configured to display a current amount of the pot.

27. The gaming table of claim 15, wherein the electronic controller is further configured to determine the lowest hand that comprises a qualifying hand in accordance with a predetermined ranking of poker hands.

28. A computer-accessible storage media including an executable program code, the executable program code configured to cause a processor to:
define a qualifying hand;
deal an initial hand of at least one card to each of one or more players by way of a respective user interface coupled to the processor;
record a bet into a pot from at least one of the players by way of the respective user interface;
deal at least one later card to each betting player by way of the respective user interface; and
award the pot to any betting player who has a lowest hand that comprises a qualifying hand by way of the respective user interface, or, if no player has a qualifying hand, repeat the dealing an initial hand and the recording a bet and the dealing at least one later card, and including in the pot at least a portion of any previously unawarded pot or pots until the pot is awarded.

29. The computer-accessible storage media of claim 28, and wherein the executable program code is further configured to cause the processor to award a predetermined portion of the pot to any betting player who has a lowest hand that does not comprise a qualifying hand by way of the respective user interface, if no player has a qualifying hand.

30. The computer-accessible storage media of claim 28, and wherein the executable program code is further configured to cause the processor to exchange a respectively selected number of cards between the processor and each betting player electing to draw during the dealing at least one later card.

31. The computer-accessible storage media of claim 28, and wherein the executable program code is further configured to cause the processor to record an additional bet into the pot from each betting player by way of the respective user interface before the dealing at least one later card.

32. The computer-accessible storage media of claim 28, and wherein the executable program code is further configured to cause the processor to record an ante from each of the one or more players by way of the respective user interface before the dealing an initial hand.

33. The computer-accessible storage media of claim 32, and wherein the executable program code is further configured to cause the processor to:
add a predefined portion of a sum of the antes to a progressive jackpot; and
award at least a portion of the progressive jackpot to an anteing player achieving a corresponding predefined hand by way of the respective user interface.

34. The computer-accessible storage media of claim 28, and wherein the executable program code is further configured to cause the processor to deal the initial hand and the at least one later card in a face-up condition.

35. The computer-accessible storage media of claim 28, and wherein the executable program code is further configured to cause the processor to extract a rake from the collective pot for a house.

36. The computer-accessible storage media of claim 28, and wherein the executable program code is further configured to cause the processor to determine lowest hand that comprises a qualifying hand in accordance with a predetermined ranking of poker hands.

37. A method of playing a poker game, comprising:
defining a qualifying hand;
collecting an ante from each of one or more players;
dealing an initial hand of at least one card to each of the players;
accepting a bet into a pot from at least one of the players;
dealing at least one additional card to one or more of the betting players; and
awarding the pot to any betting player who has a lowest hand that comprises a qualifying hand in accordance with a predetermined lo-ball ranking of poker hands, or, if no player has a qualifying hand, repeating the collecting an ante and the dealing an initial hand and the accepting a bet and the dealing at least one additional card, and including in the pot at least a portion of any previously unawarded pot or pots until the pot is awarded.

38. The method of claim 37, and further comprising, if no player has a qualifying hand, awarding a predetermined portion of the pot to any betting player who has a lowest hand that exceeds the qualifying hand in accordance with the predetermined lo-ball ranking of poker hands.

39. The method of claim 37, wherein the dealing at least one additional card to one or more betting players is defined by respectively exchanging one or more cards between a house and each betting player electing to draw.

40. The method of claim 37, wherein the qualifying hand is defined by a hand including no content greater than one of: a nine, a ten, a face card, a pair, two pair, three of a kind, a full house, or four of a kind.

41. The method of claim 37, wherein flushes and straights are ignored in the ranking of hands.

42. The method of claim 37, wherein aces are ranked the lowest in the ranking of cards.

43. The method of claim 37, and further comprising extracting a rake out of the pot by a house after the accepting a bet.

44. The method of claim 37, and further comprising extracting a predefined percentage of the pot after the accepting a bet.

45. The method of claim 37, wherein the initial hand and the at least one additional card are dealt in a face-up condition.

46. The method of claim 37, and further comprising:
extracting a predefined portion from a sum of the antes after the collecting an ante from each of one or more players;
adding the predefined portion to a progressive jackpot; and
awarding at least a portion of the progressive jackpot to a player achieving a corresponding predefined hand.

47. The method of claim 37, wherein at least two players play the poker game by way of an electronic gaming table.

48. The method of claim 37, wherein one or more players play the poker game by way of respective mutually communicative individual gaming machines.

49. A method of playing a poker game, comprising:
defining a qualifying hand;
dealing an initial hand of at least one card to each of one or more players;
accepting a bet into a pot from at least one of the players; and
awarding the pot to any betting player who has a hand that comprises a best qualifying hand, or, if no player has a qualifying hand, awarding a predetermined portion of the pot to any betting player who has a best hand that does not comprise a qualifying hand and then repeating the dealing an initial hand and the accepting a bet, and including in the pot any previously unawarded portion of the pot.

50. The method of claim 49, and wherein the best hand that does not comprise a qualifying hand is based on a high card count.

51. The method of claim 49, and wherein the best hand that does not comprise a qualifying hand is based on a low card count.

52. A method of playing a game of chance for multiple players in a player-versus-player environment, wherein the game of chance is hosted by a house, the method comprising:
accepting from each player wishing to engage in the game a bet which is added to a pot;
providing each player who placed a bet with media from which those players each determine whether or not to continue play;
for each player wishing to continue play, providing those players with one or more additional media, and accepting additional bets from players wishing to continue play and who have a predefined qualifying position;
adding the additional bets to the pot; and
awarding the pot to a player have a predefined best position from among players having the predefined qualifying position, or, if no player has the predefined qualifying position, awarding a portion of the pot to a player having a predefined best non-qualifying position and placing the remainder of the pot in a rolls-over pot to be applied to a next event of play of the game.

53. The method of claim 52, and further comprising collecting from each player wishing to engage in the game an ante, and retaining the ante for the house.
